(19) United States
(12) Patent Application Publication
(10) Pub. No.: US 2012/0084059 A1
(43) Pub. Date: Apr. 5, 2012

(54) DATA ACQUISITION METHOD OF SUBSTRATE TREATMENT APPARATUS AND SENSOR SUBSTRATE

(75) Inventor: Hikaru AKADA, Koshi City (JP)

(73) Assignee: Tokyo Electron Limited, Tokyo (JP)

(21) Appl. No.: 13/238,214

(22) Filed: Sep. 21, 2011

(30) Foreign Application Priority Data
Oct. 1, 2010 (JP) 2010-224182

(51) Int. Cl. G06F 15/00

(52) U.S. Cl. 702/188

(57) ABSTRACT

The present invention holds a sensor substrate including a sensor part for collecting information about a module and a power receiving coil for supplying power to the sensor part, on a holding member; moves the holding member forward to deliver the sensor substrate to the module; supplies power to a power transmitting coil provided at a base of the holding member to form a magnetic field, and causes the power transmitting coil and the power receiving coil to resonate in the magnetic field to supply power from the power transmitting coil to the power receiving coil; and acquires data about the module by the sensor part.

### BACKGROUND OF THE INVENTION

1. Field of the Invention

The present invention relates to a data acquisition method of a substrate treatment apparatus including a plurality of modules and a sensor substrate used in the data acquisition method.

2. Description of the Related Art

In the photoresist process that is one of semiconductor manufacturing processes, a resist is applied to the front surface of a semiconductor wafer (hereinafter, referred to as a wafer) being a substrate, the resist is exposed in a predetermined pattern and then developed to form a resist pattern. For the formation of the resist pattern, a coating and developing apparatus is used and includes modules performing various kinds of treatments on the wafer.

To accurately perform treatments on the wafer without occurrence of poor condition, it is necessary to acquire data about each of the modules in the coating and developing apparatus before operation of the apparatus and at inspection subsequent thereto. In the solution treatment module applying a treatment solution such as, for example, a resist to the wafer, a spin chuck suction-holding the central portion of the rear surface of the wafer and rotating the wafer is provided so that the treatment solution supplied on the rotation center of the wafer is spread out by the centrifugal force. To form a highly uniform film with the treatment solution, inspection is conducted before the operation of the apparatus to specify the position of the rotation center of the spin chuck. Then, the wafer is mounted on the spin chuck such that the center of the wafer aligns with the rotation center of the spin chuck at the time of treatment of the wafer. The technique of specifying the rotation center of the spin chuck as described above is disclosed in Japanese Laid-open Patent Publication No 2007-311775. Further, in a heating module performing heat processing on the wafer, data on the heating temperature of the wafer is acquired.

For such data acquisition, sensor wafers having various sensors mounted thereon are used, and a battery separate from the wafer is wire-connected to the sensor wafer via a cable and the sensor wafer is transferred to each of the modules for inspection in some cases. However, in such a case of wire-connecting them, the operator needs to individually transfer the sensor wafer into each of the modules and spend care thereon. Hence, to increase the efficiency of acquiring data, the battery is constituted of a lithium ion secondary battery and directly mounted on the sensor wafer, and sequentially transferred among the modules by a substrate transfer mechanism of the coating and developing apparatus to acquire data in some cases. The technique of conducting inspection using the sensor wafer having the battery mounted thereon is disclosed in the aforementioned Japanese Laid-open Patent Publication No 2007-311775 and Japanese Laid-open Patent Publication No 2008-109027.

However, the coating and developing apparatus includes many modules in order to increase the throughput. Therefore, when trying to perform measurement spending a predetermined time in all of the modules, the battery mounted on the sensor wafer needs to have a large capacity and therefore becomes large and heavy. In this case, the circumstances of the module differ from those at the time when the actual wafer is transferred thereinto, thus possibly reducing the accuracy of acquired data.

Further, in the case of measuring the heating temperature in the above-described heating module, the battery composed of the above-described lithium-ion secondary battery could not normally operate in a high temperature atmosphere. Therefore, it is difficult to configure the sensor wafer measuring the temperature in the heating module such that the battery is mounted thereon, and it is necessary to use the sensor wafer to which the separate battery is connected via a cable as has been described.

### SUMMARY OF THE INVENTION

The present invention has been made under such circumstances and its object is to provide a technique capable of efficiently acquiring data about each of modules of a substrate treatment apparatus and conducting highly accurate inspection.

The data acquisition method of the substrate treatment apparatus of the present invention is a method of acquiring data of a substrate treatment apparatus including a substrate transfer mechanism including a base and a holding member provided on the base to be movable forward and backward, for transferring a substrate between a plurality of modules, the method including the steps of: holding a sensor substrate on the holding member, the sensor substrate including a sensor part for collecting information about the module and a power receiving coil for supplying power to the sensor part; then moving the holding member forward to deliver the sensor substrate to the module; supplying power to a power transmitting coil moving together with the base to form a magnetic field, and causing the power transmitting coil and the power receiving coil to resonate in the magnetic field to supply power from the power transmitting coil to the power receiving coil; and acquiring data about the module by the sensor part.

The present invention according to another aspect is a method of acquiring data of a substrate treatment apparatus including a substrate transfer mechanism including a base and a holding member provided on the base to be movable forward and backward, for transferring a substrate between a plurality of modules, the method including the steps of: holding a sensor substrate on the holding member, the sensor substrate including a sensor part for collecting information about the module and a first power receiving coil for supplying power to the sensor part; then moving the holding member forward to deliver the sensor substrate to the module; holding a power transmitting substrate including a first power transmitting coil, on the holding member; supplying power to the first power transmitting coil to form a magnetic field, and causing the first power transmitting coil and the first power receiving coil to resonate in the magnetic field to supply power from the first power transmitting coil to the first power receiving coil; and acquiring data about the module by the sensor part.

According to still another aspect, the present invention is a sensor substrate configured to be transferable by a substrate transfer device to a module into which a substrate being a treatment object is transferred, the sensor substrate including: a sensor part for collecting various kinds of data information supplied for process treatment in the module; a transmission part wirelessly transmitting the data information collected by the sensor part; and a power receiving coil connected to the sensor part and transmission part, for receiving power transmitted by a resonance effect from an outside and supplying the power to the sensor part and transmission part.

According to the present invention, it is possible to suppress the capacity of a battery provided on a sensor substrate or it is unnecessary to provide the battery itself on the sensor substrate. In addition, the sensor substrate can be delivered between modules using a substrate transfer mechanism, thus avoiding an increase in data acquisition time. Further, since the size and weight of the sensor substrate can be suppressed, the degree of freedom of the weight and shape of the sensor substrate is increased to ensure highly accurate inspection.

### BRIEF DESCRIPTION OF THE DRAWINGS

FIG. 1 is a plan view of a coating and developing apparatus according to an embodiment of the present invention;

FIG. 2 is a perspective view of the coating and developing apparatus in FIG. 1;

FIG. 3 is a longitudinal section side view of the coating and developing apparatus in FIG. 1;

FIG. 4 is a longitudinal section side view of an anti-reflection film forming module provided in the coating and developing apparatus in FIG. 1;

FIG. 5 is a perspective view of a transfer arm in the coating and developing apparatus in FIG. 1;

FIG. 6 is a plan view of a power transmitting coil provided on the transfer arm in FIG. 5;

FIG. 7 is a longitudinal section side view of a waiting module provided in the coating and developing apparatus;

FIG. 8 is an equivalent circuit diagram of the coating and developing apparatus and a sensor wafer;

FIG. 9 is a schematic circuit diagram of the coating and developing apparatus;

FIG. 10 is a plan view of the sensor wafer;

FIG. 11 is an explanatory view illustrating the operation of the transfer arm;

FIG. 12 is an explanatory view illustrating the operation of the transfer arm;

FIG. 13 is an explanatory view illustrating the operation of the transfer arm;

FIG. 14 is an explanatory view illustrating the operation of the transfer arm;

FIG. 15 is an explanatory view illustrating the operation of the transfer arm;

FIG. 16 is an explanatory view illustrating the operation of the transfer arm;

FIG. 17 is a flowchart illustrating the process of acquiring data about a module;

FIG. 18 is a plan view of the anti-reflection film forming module in acquiring data;

FIG. 19 is a plan view of another configuration example of the transfer arm;

FIG. 20 is a side view of the transfer arm in FIG. 19;

FIG. 21 is a plan view of a power transmitting wafer;

FIG. 22 is a schematic circuit diagram of the power transmitting wafer;

FIG. 23 is a side view of the anti-reflection film forming module in acquiring data;

FIG. 24 is a side view of a heating module in acquiring data;

FIG. 25 is a side view of a heating module in acquiring data;

FIG. 26 is a side view of a waiting module;

FIG. 27 is a schematic diagram illustrating transmission and reception of signals and supply of power;

FIG. 28 is a schematic diagram illustrating transmission and reception of signals and supply of power;

FIG. 29 is a plan view of a power transmitting wafer in another configuration; and

FIG. 30 is a schematic circuit diagram of the power transmitting wafer in FIG. 29.

### DETAILED DESCRIPTION OF THE INVENTION

### First Embodiment

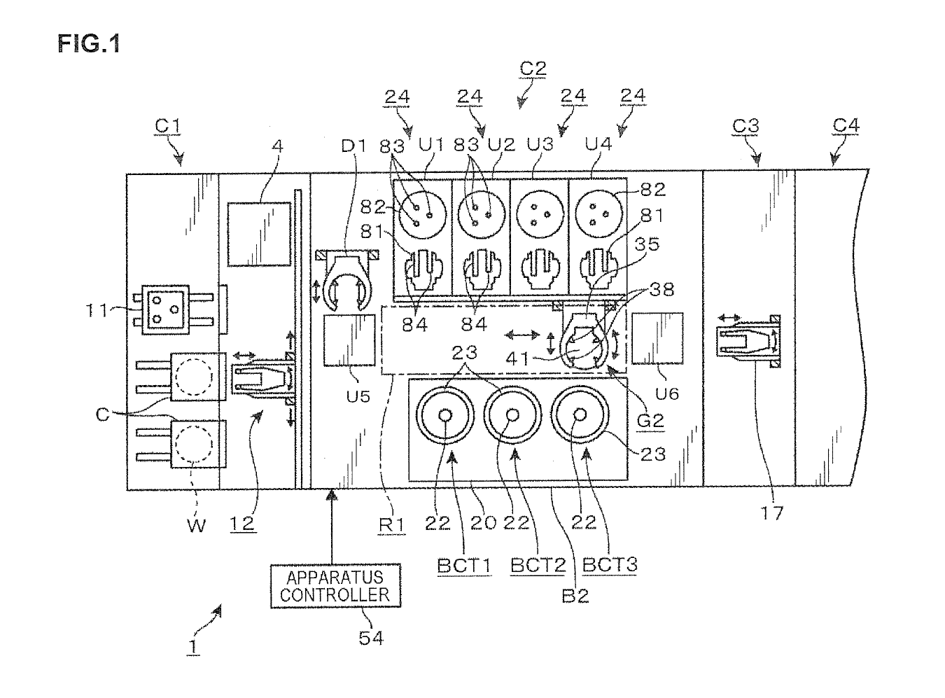

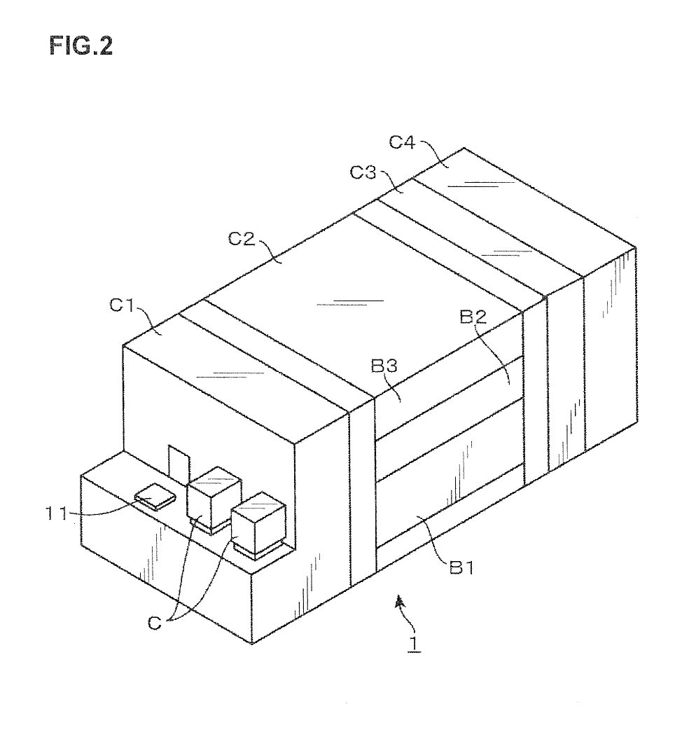

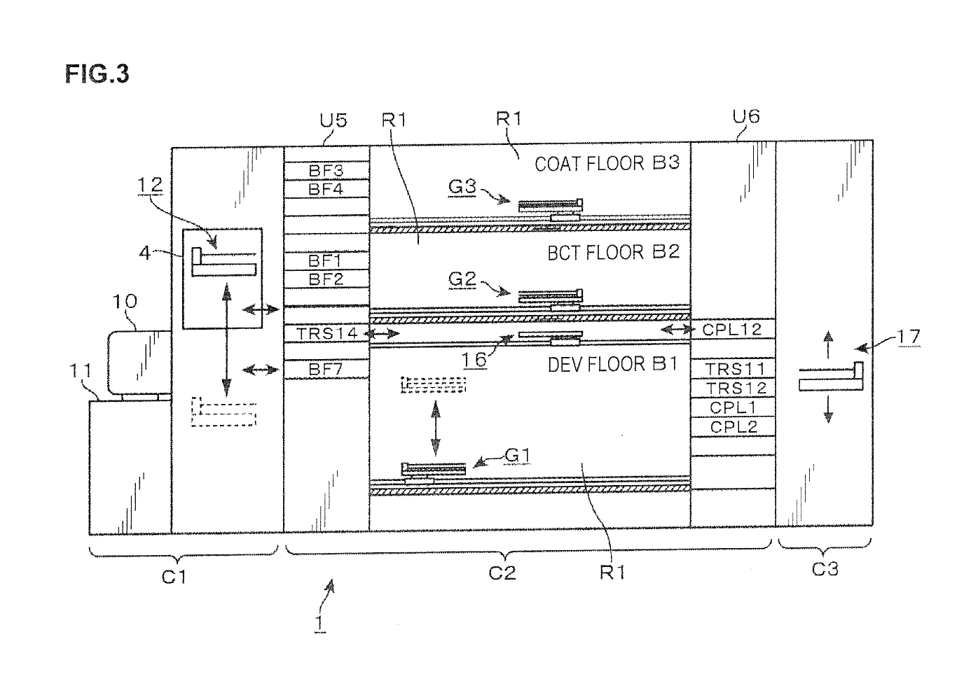

The configuration of a coating and developing apparatus 1 being a substrate treatment apparatus to which the present invention is applied and the transfer route of a wafer W for manufacturing a semiconductor device will be described. FIG. 1 illustrates a plan view of a resist pattern forming system in which an aligner C4 is connected to the coating and developing apparatus 1, and FIG. 2 is a perspective view of the system. Further, FIG. 3 is a longitudinal sectional view of the coating and developing apparatus 1.

In the coating and developing apparatus 1, a carrier block C1 is provided and configured such that a delivery arm 12 takes a wafer W out of a closed-type carrier C mounted on a mounting table 11 of the carrier block C1 and delivers it to a treatment block C2 and the delivery arm 12 receives a treated wafer W from the treatment block C2 and returns it to the carrier C.

The treatment block C2 is constituted of, in this example, a first block (DEV floor) B1 for performing developing treatment, a second block B2 for forming an anti-reflection film under a resist film, and a third block (COT floor) B3 for forming a resist film, which are stacked in order from the bottom as illustrated in FIG. 2.

Each of the floors of the treatment block C2 has a similar configuration in a plan view. Explaining the configuration taking the second block (BCT floor) B2 as an example, the BCT floor B2 has an anti-reflection film forming unit 21 forming an anti-reflection film that is pre-treatment for forming, for example, a resist film as a coating film, shelf units U1 to U4 each constituted of modules of heating system, and a transfer arm G2 provided between the anti-reflection film forming unit 21 and the shelf units U1 to U4 and delivering the wafer W between the modules included in the units. The module refers to a place in which the wafer W is placed.

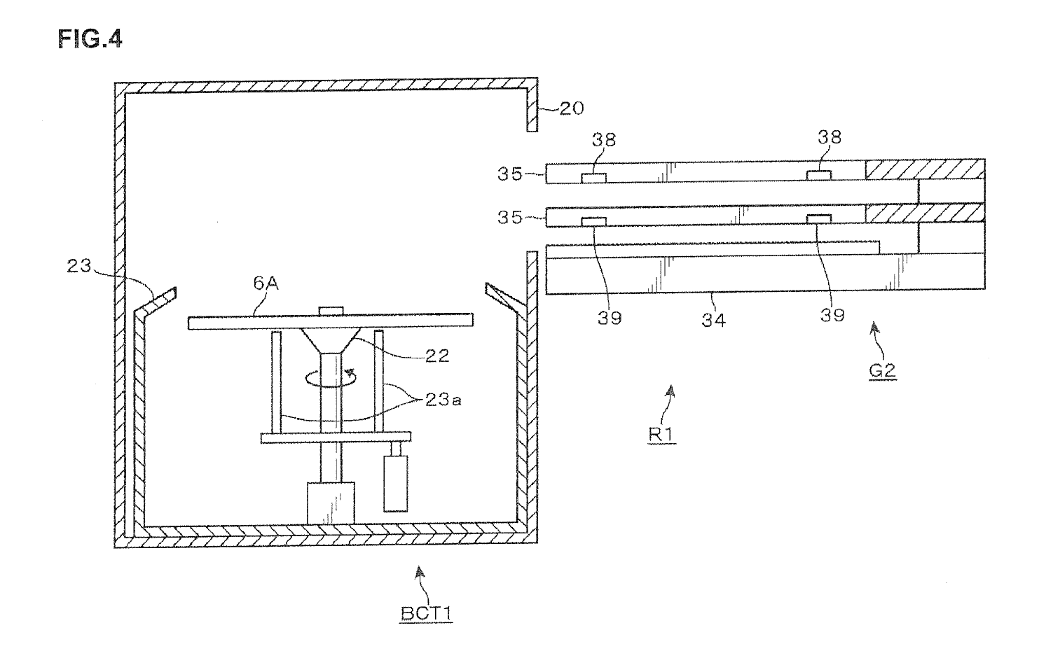

Explaining with reference also to FIG. 4, the anti-reflection film forming unit 21 includes three anti-reflection film forming modules BCT1 to BCT3. The anti-reflection film forming modules BCT1 to BCT3 have a common housing 20 and each has a spin chuck 22 holding the center portion of the rear surface of the wafer W and rotating the wafer W around the vertical axis in the housing 20. The anti-reflection film forming modules BCT1 to BCT3 further have a treatment solution supply nozzle (not illustrated) supplying a treatment solution onto the center portion of the front surface of the wafer W held on and rotated by the spin chuck 22. The treatment solution spreads over the entire wafer W by the centrifugal force. In the drawing, 23 denotes a cup for suppressing scatter of the treatment solution, and 23a denotes three raising and lowering pins (only two of them are illustrated in the drawing) for delivering the wafer W between the spin chuck 22 and an upper fork 35.

The shelf units U1 to U4 are arranged along a transfer region R1 being a horizontal straight transfer path along which the transfer arm G2 moves. In each of the shelf units U1 to U4, two heating modules 24 are stacked one upon the other. The heating module 24 has a hot plate (not illustrated) so that the wafer mounted on the hot plate is subjected to heat processing. The configuration of the heating module 24 will be described in detail in a second embodiment.

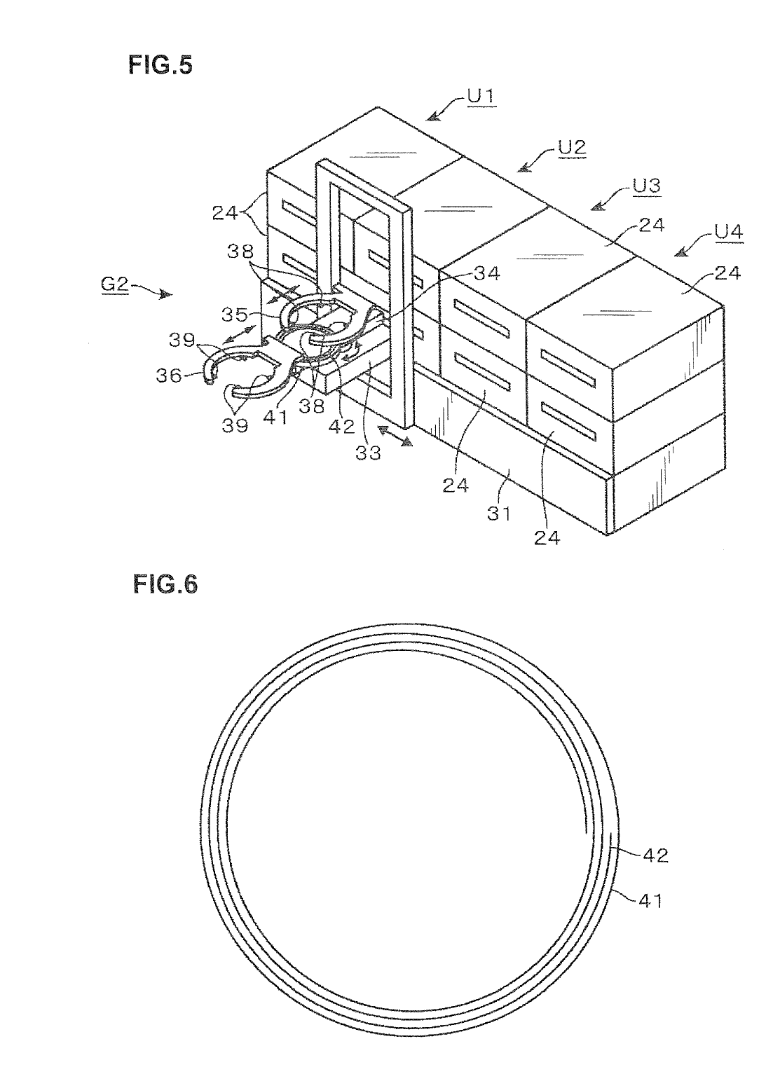

The transfer arm G2 is described using FIG. 5. The transfer arm G2 has a guide 31 extending in the horizontal direction from the carrier block C1 side toward an interface block C3 side, and a frame 32 moves along the guide 31. On the frame 32, a lift table 33 moving up and down along the vertical axis is provided, and a base 34 turning around the vertical axis is provided on the lift table 33. The base 34 has an upper fork 35 and a lower fork 36 surrounding the side circumference of the wafer W. The upper fork 35 and the lower fork 36 move forward and backward independently in the horizontal direction on the base 34 to access modules. The upper fork 35 and the lower fork 36 are provided with rear surface supporting parts 38, 39 supporting the rear surface of the wafer W respectively. A disk 41 is provided on the base 34, and a power transmitting coil 42 is provided at the peripheral portion of the disk 41. FIG. 6 is a plan view of the disk 41. The power transmitting coil 42 is a planar coil, and a conductive wire of the coil is provided in a spiral form at the peripheral portion of the front surface of the disk 41.

In the third block (COT floor) B3, resist film forming modules COT1 to COT3 are provided at positions corresponding to the anti-reflection film forming modules BCT1 to BCT3. The COT floor B3 has the same configuration as that of the BCT floor B2 except that resist is supplied to the wafer W in place of the treatment solution for forming the anti-reflection film in each module, and includes a transfer arm G3 similar to the transfer arm G2.

In the first block (DEV floor) B1, developing treatment units corresponding to the anti-reflection film forming units 21 are stacked at two stages in one DEV floor B1, and the developing treatment unit includes a developing module DEV. The developing module DEV, the anti-reflection film forming module BCT, and the resist film forming module COT are collectively called a solution treatment module.

Further, the DEV floor B1 includes shelf units U1 to U4 as in the BCT floor B2, and heating modules constituting the shelf units U1 to U4 include a plurality of heating modules (PEB) performing heat processing before the developing treatment and a plurality of heating modules (POST) performing heat processing on the wafer W after the developing treatment. The transfer arm G1 of the DEV floor B1 transfers the wafer W to each of the developing modules DEV and each of the heating modules. In short, the transfer arm G1 is common to the developing treatment units at the two stages. The transfer arm G1 is configured similarly to the transfer arm G2.

In the treatment block C2, a shelf unit U5 is provided as illustrate in FIG. 1 and FIG. 3, and the wafer W from the carrier block C1 is transferred to one delivery module BF1 in the shelf unit U5. The transfer arm G2 of the BCT floor B2 receives the wafer W from the delivery module BF1 and transfers the wafer W to one of the anti-reflection film forming modules BCT1 to BCT3, and then transfers the wafer W on which the anti-reflection film is formed to the heating module 24.

The transfer arm G2 then transfers the wafer W to a delivery module BF2 of the shelf unit U5, and the wafer W is sequentially transferred by a delivery arm D1 to a delivery module BF3 corresponding to the third block (COT floor) B3. The transfer arm G3 in the third block (COT floor) B3 receives the wafer W from the delivery module BF3, transfers the wafer W to one of the resist film forming modules COT1 to COT3 and, after a resist film is formed on the wafer W in the resist film forming module, transfers the wafer W to the heating module 24.

Thereafter, the wafer W is subjected to heat processing in the heating module and then transferred to a delivery module BF4 in the shelf unit U5. On the other hand, at the upper portion in the DEV floor B1, a shuttle 16 being a dedicated transfer means for directly transferring the wafer W from a delivery module TRS14 provided in the shelf unit U5 to a delivery module TRS15 provided in the shelf unit U6 is provided. The wafer W on which the resist film is formed is delivered from the delivery module BF4 to the delivery module TRS14 by the delivery arm D1 and delivered to the shuttle 16 at the delivery module TRS14.

The shuttle 16 transfers the wafer W to the delivery module TRS15 in the shelf unit U6, and the wafer W is received by an interface arm 17 provided in the interface block C3 and transferred to the interface block C3. Note that a delivery module with a symbol CPL in FIG. 3 also functions as a cooling module for temperature regulation, and a delivery module with a symbol BF also functions as a buffer module in which a plurality of wafers W can be mounted.

Then, the wafer W is transferred by the interface arm 17 to the aligner C4 and subjected to exposure processing. Subsequently, the wafer W is transferred by the interface arm 17 to a delivery module TRS11 or TRS12 in the shelf unit U6, and transferred by the transfer arm G1 in the first block (DEV floor) B1 to the heating module (PEB) included in the shelf units U1 to U4 and subjected to heat processing.

The wafer W is then transferred by the transfer arm G1 to the delivery module CPL1 or CPL2, and then transferred to the developing module DEV and subjected to developing treatment. The wafer W is then transferred to one of the heating modules (POST) and subjected to heat processing. The wafer W is then delivered by the transfer arm G1 to the delivery module BF7 in the shelf unit U5. The wafer W is then returned to the position at which the carrier C is originally placed, via the delivery arm 12.

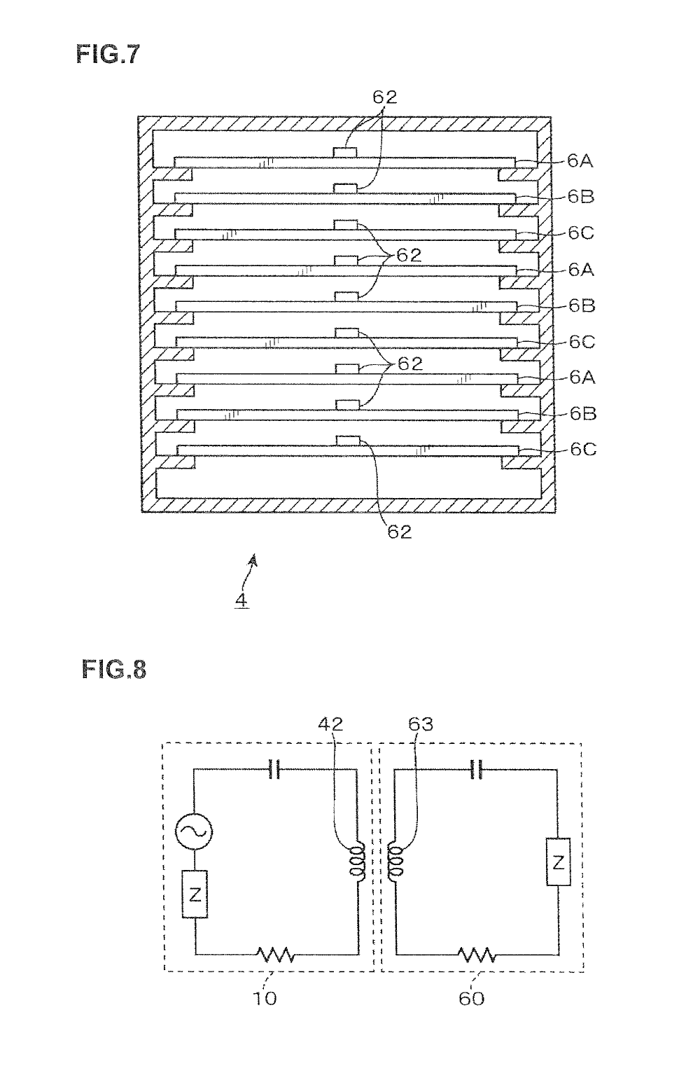

In the above-described carrier block C1, a waiting module 4 is provided at the position to which the delivery arm 12 can access. FIG. 7 illustrates a longitudinal section side view of the waiting module 4, and sensor wafers 6A to 6C on which various sensors are mounted are stored in the waiting module 4. The waiting module 4 is configured in the form of shelves to be able to support peripheries of the sensor wafers 6A to 6C and store the sensor wafers 6A to 6C in the vertical direction. Hereinafter, the sensor wafers 6A to 6C are collectively described as a sensor wafer 6. The sensor wafer 6 is a wafer for collecting data about modules and has a configuration different from that of the wafer W for manufacturing a semiconductor device, but can be transferred between modules as with the wafer W. The configuration of the sensor wafer 6 will be described later in detail.

The outline of the first embodiment will be described here. In this first embodiment, the sensor wafer 6 is transferred to an arbitrary module, and non-contact power supply from the coating and developing apparatus 1 to the sensor wafer 6 is performed by a magnetic field resonance system. The sensor wafer 6 collects data about the module using the power supplied as in the above manner. FIG. 8 illustrates an equivalent circuit 10 of a circuit provided in the coating and developing apparatus 1 for performing the non-contact power supply and an equivalent circuit 60 of a circuit provided in the sensor wafer 6 for performing the non-contact power supply. The equivalent circuits 10, 60 are constituted as resonant circuits each including a coil and a capacitor. The already-described power transmitting coil 42 of the transfer arm G corresponds to the equivalent circuit 10 and a later-described power receiving coil 63 provided in the sensor wafer 6 corresponds to the equivalent circuit 60. When the alternating current of a resonance frequency flows through the equivalent circuit 10, a magnetic field is formed between the power transmitting coil 42 and the power receiving coil 63, and the power receiving coil 63 resonates with the power transmitting coil 42 in the magnetic field, so that an electric current of the resonance frequency is induced in the power receiving coil 63 to supply power to the equivalent circuit 60. As the resonance frequency supplied to the equivalent circuit 10, a frequency, for example, in the 13.56 MHz band.

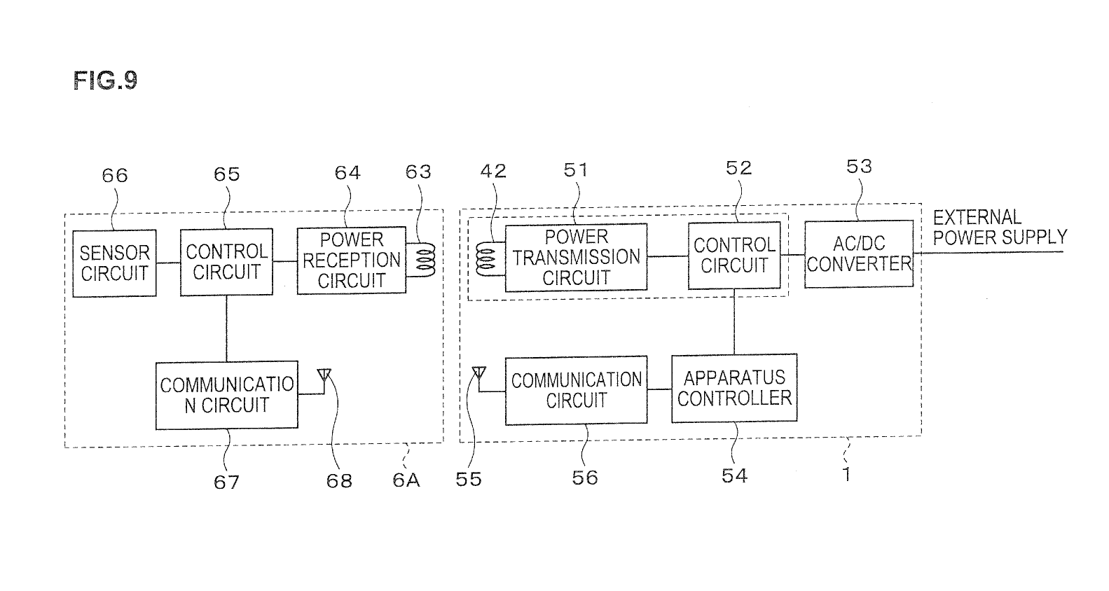

FIG. 9 illustrates the circuit configurations of the coating and developing apparatus 1 and the sensor wafer 6A. The power transmitting coil 42 provided in the transfer arm G is connected to a power transmission circuit 51 for transmitting the alternating current to the power transmitting coil 42, and a control circuit 52 controls the power supplied to the power transmission circuit 51. The power transmission circuit 51 and the control circuit 52 are provided in each of the transfer arms G1 to G3 and, for example, the control circuit 52, the power transmission circuit 51, and the coil 42 correspond to the above-described equivalent circuit 10. At the stage previous to the control circuit 52, an AC/DC converter 53 is connected so that the alternating current supplied from an alternating-current source outside the coating and developing apparatus 1 is converted into the direct current in the converter 53 and supplied to each of the circuits on the subsequent stage side. Further, the control circuit 52 is connected to an apparatus controller 54. The apparatus controller 54 will be described later.

The coating and developing apparatus 1 has an antenna 55, and the antenna 55 wirelessly receives data about the module transmitted from the sensor wafer 6, a power reception confirmation signal indicating that power has been supplied to the sensor wafer 6, and a power transmission stop signal controlling the stop of power transmission to the power transmitting coil 42. The signals received by the antenna 55 are outputted to the apparatus controller 54 via a communication circuit 56 controlling the communication through the antenna 55.

The apparatus controller 54 is composed, for example, a computer and has a program storage part (not illustrated). In this program storage part, a program is stored which is composed of, for example, software in which a command is created to perform the above-described and later-described transfers to execute a transfer cycle. The program is read to the apparatus controller 54, whereby the apparatus controller 54 transmits control signals to the units and the like of the coating and developing apparatus 1. This controls the operations of the units and the like in the coating and developing apparatus 1 to control the operation of each of the modules and the delivery of each wafer among the modules. This program is stored in the program storage part in a state that it is held in a storage medium such as, for example, a hard disk, a compact disk, a magneto-optical disk or a memory card.

The upper fork 35, the lower fork 36 and the base 34 of each transfer arm G output signals according to their positions to the apparatus controller 54. The apparatus controller 54 controls the timing to start power supply to the power transmitting coil 42 according to the positional signal of each of them as described later.

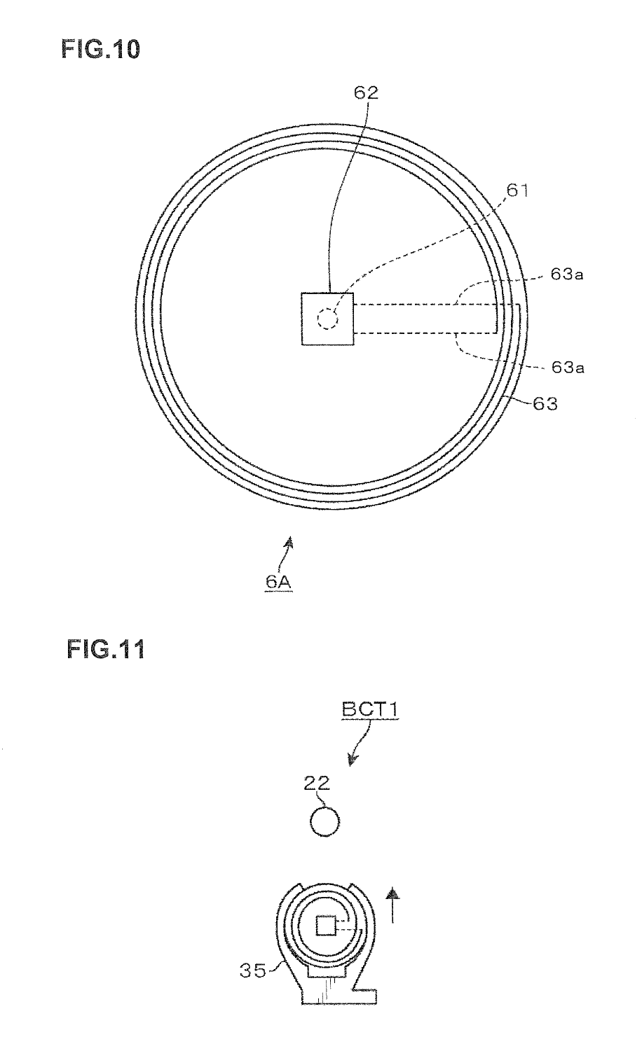

The configuration of the sensor wafer 6 will be described next. The sensor wafers 6A to 6C are similarly configured except that the kinds of the sensors mounted on them are different, and the sensor wafer 6A will be described here as a representative of them. The sensor wafer 6A includes, for example, an acceleration sensor and is used for detecting the position of the rotation center of the spin chuck 22 as has been previously described in the item of the Background of the Invention. FIG. 10 illustrates the front surface of the sensor wafer 6A. On the front surface, a circuit unit 62 including an acceleration sensor 61 is provided. The acceleration sensor 61 is located at the center of the sensor wafer 6A, and when the sensor wafer 6A is rotated on the spin chuck 22 and acceleration acts on the acceleration sensor 61, the sensor wafer 6A transmits a signal according to the acceleration to the apparatus controller 54. The apparatus controller 54 calculates the rotation center of the spin chuck 22 based on the signal. Further, the power receiving coil 63 connected to the circuit unit 62 is provided at the peripheral portion of the sensor wafer 6. The power receiving coil 63 is a planar coil, and the conductive wire of the coil is provided in a spiral form at the peripheral portion of the sensor wafer 6. A dotted line 63a in the drawing is a wire connecting the power receiving coil 63 to the circuit unit 62.

Returning to FIG. 9, the schematic circuit configuration of the sensor wafer 6A will be described. The power receiving coil 63 is connected to a power reception circuit 64, and power is supplied from the power reception circuit 64 to circuits at the subsequent stage. The power reception circuit 64 is connected to a control circuit 65, and a sensor circuit 66 constituting the acceleration sensor 61 and a communication circuit 67 are connected to the control circuit 65. An antenna 68 is connected to the communication circuit 67. The control circuit 65 controls the power supplied to the sensor circuit 66 and the communication circuit 67. The data acquired by the sensor circuit 66 is outputted to the communication circuit 67 via the control circuit 65 and wirelessly transmitted from the antenna 68 to the apparatus controller 54 via the antenna 55. Note that for wireless communication in the magnetic field in which power is wirelessly supplied, the communication frequency between the antenna 68 and the antenna 55 is set to a frequency different from the resonance frequency or wireless power supply.

Explaining the other sensor wafers 6, the sensor wafer 6B includes a temperature sensor, in place of the acceleration sensor 61, in order to acquire, for example, data on the heating temperature for the wafer in the heating module in each floor. In more concrete explanation, the data on the heating temperature is data in which, for example, all temperature changes of the wafer in the heat processing process in the heating module are recorded in association with the process time. The sensor wafer 6C includes a humidity sensor and an air speed sensor for measuring the humidity, the direction and the air speed of airflow in each module, in place of the acceleration sensor 61, to measure the humidity state in the process in the module, the direction and the air speed of airflow flowing during the process. Except the difference of the sensor and the data acquired by the sensor, the sensor wafers 6 are mutually similarly configured.

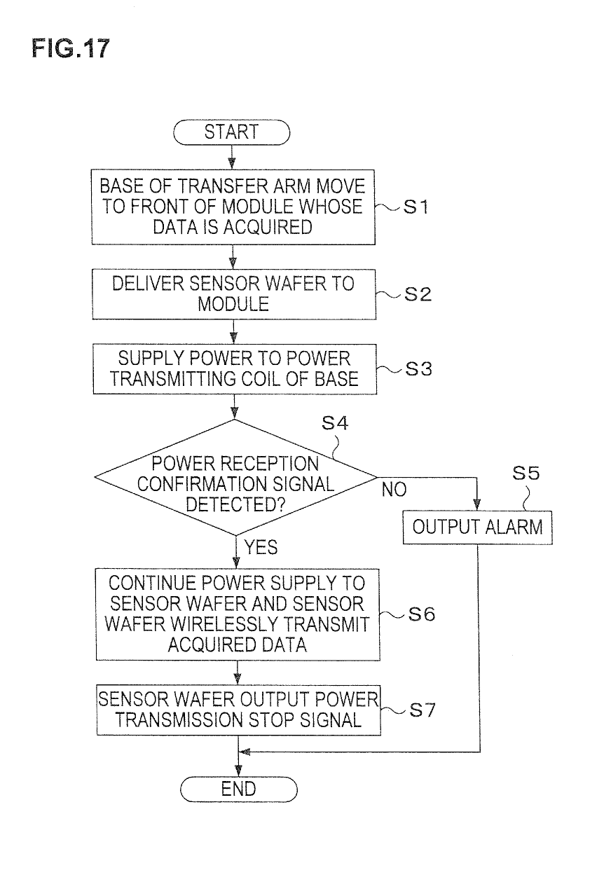

Subsequently, the method of acquiring data by the sensor wafer 6A will be described referring to explanatory views illustrating the operation of the transfer arm G2 in FIG. 11 to FIG. 16 and the flowchart in FIG. 17. The sensor wafer 6A is transferred among the floors through the same route as that of the wafer W. However, in each of the floors, the sensor wafer 6A is transferred in sequence to all of the solution treatment modules but not to the heating modules constituting the shelf units U1 to U4 unlike the case of the wafer W.

In the state that the treatment on the wafer W is suspended in the coating and developing apparatus 1, when the user performs a predetermined operation, for example, from an operation unit (not illustrated) provided in the apparatus controller 54 to order acquisition of data by the sensor wafer 6A, the sensor wafer 6A is transferred by the delivery arm 12 from the waiting module 4 to the delivery module BF1 and received by the upper fork 35 of the transfer arm G2. Subsequently, the base 34 of the transfer arm G2 moves from the front of the delivery module BF1 to the front of the anti-reflection film forming module BCT1 in the transfer region R1 (FIG. 11, Step S1).

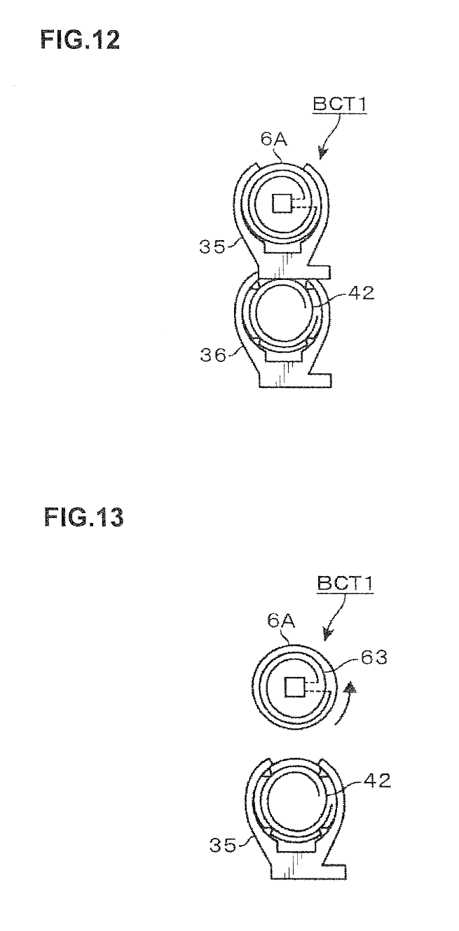

The upper fork 35 moves forward to the anti-reflection film forming module BCT1 and delivers the sensor wafer 6A to the spin chuck 22 (FIG. 12, Step S2). Subsequently, when the upper fork 35 moves backward on the base 34, electric current is supplied to the power transmitting coil 42 of the transfer arm G2 regarding, as a trigger, the positional signal outputted when the upper fork 35 completely moves back and supplied in a non-contact manner to the power receiving coil 63 of the sensor wafer 6A by magnetic field resonance as has been described (Step S3). Note that FIG. 4 illustrates the sensor wafer 6A during the non-contact power supply.

When power is supplied from the power receiving coil 63 to the circuits at the subsequent stage and the circuits start up, a power reception confirmation signal is wirelessly transmitted from the antenna 68 to the coating and developing apparatus 1. The apparatus controller 54 judges whether or not the power reception confirmation signal has been received (Step S4), and when it has not been received, for example, the power supply to the power transmitting coil 42 is stopped and an alarm is displayed on a not-illustrated display screen constituting the apparatus controller 54 (Step S5). When the power reception confirmation signal has been received, the power supply to the power transmitting coil 42 is continued and the acceleration sensor 61 mounted on the sensor wafer 6 starts measurement of data, and the spin chuck 22 rotates at a predetermined angular speed (FIG. 13). During the power supply to the power transmitting coil 42, the base 34 waits in front of the anti-reflection film forming module BCT1.

The data acquired by the acceleration sensor 61 is transmitted to the apparatus controller 54 via the antenna 68 (Step S6), the apparatus controller 54 analyzes the data to detect to detect the acceleration acting on the acceleration sensor 61 and calculate the eccentric distance between the rotation center of the spin chuck 22 and the rotation center of the sensor wafer 6A based on the acceleration. After the data acquisition, the sensor wafer 6A outputs a power transmission stop signal from the antenna 68 to the coating and developing apparatus 1 (Step S7). Upon receiving the power transmission stop signal, the coating and developing apparatus 1 stops once the power supply to the power transmitting coil 42 to stop the rotation of the spin chuck 22. Thereafter, the sensor wafer 6A is delivered to the upper fork 35 moved forward to the anti-reflection film forming module BCT1, and the sensor wafer 6A is then mounted on the spin chuck 22 such that its position is deviated from the position at the previous measurement time. After the sensor wafer 6A is mounted in such a state, the processing at Steps S2 to S7 is performed again in which the eccentric distance is measured.

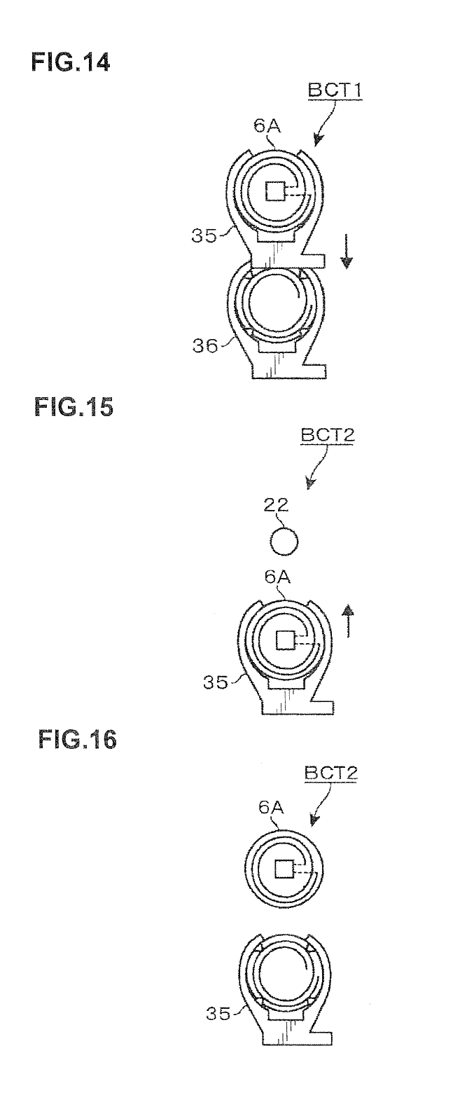

After the measurement is repeatedly performed, for example, a predetermined number of times to calculate the eccentric distances and the power supply to the power transmitting coil 42 is stopped, the rotation of the spin chuck 22 is also stopped. The apparatus controller 54 specifies the coordinates of the rotation center of the spin chuck 22 based on the obtained eccentric distances. The coordinates are specified on one hand, and the upper fork 35 moves forward to the anti-reflection film forming module BCT1 and receives the sensor wafer 6A and then moves backward on the other hand (FIG. 14). Thereafter, the base 34 of the transfer arm G2 moves to the front of the anti-reflection film forming module BCT2 (FIG. 15), and delivers the sensor wafer 6A to the spin chuck 22 of the anti-reflection film forming module BCT2. After the upper fork 35 delivered the sensor wafer 6A moves backward on the base 34, the power transmission to the power transmitting coil 42 is started (FIG. 16). Thereafter, the data of the acceleration is acquired as in the anti-reflection film forming module BCT1, and the coordinates of the rotation center of the spin chuck 22 in the anti-reflection film forming module BCT2 are specified.

Also after the measurement in the anti-reflection film forming module BCT2, the sensor wafer 6 receives, when conducting inspection, the supply of power from the transfer arm G and conducts the inspection of the solution treatment module. The sensor wafer 6 is then transferred in the order of the BCT floor B2, the COT floor B3 and the DEV floor B1 as with the wafer W being the treatment object. After completion of the inspection about all of the solution treatment modules, the sensor wafer 6 is transferred via the delivery module BF7 to the waiting module 4, and waits there. When the treatment on the wafer W is started after the completion of the inspection, the apparatus controller 54 controls the transfer of the wafer W so that the rotation center of the wafer W aligns with the rotation center of the spin chuck 22, based on the specified coordinates.

Though the transfer example of the sensor wafer 6A has been described, the user sets a sensor wafer for use according to desired measurement items through the apparatus controller 54. The set sensor wafer 6 is transferred in sequence to the floors as with the wafer W in the coating and developing apparatus 1. The sensor wafer 6B is transferred in sequence to the heating modules in the floors and acquires data on the heating temperatures for the wafer in the heating modules. The sensor wafer 6C is transferred to all of the modules performing treatment on the wafer including, for example, the solution treatment modules and the heating modules to acquire the data on the direction and the air speed of airflow and the humidity.

With the coating and developing apparatus 1 of the first embodiment, during the acquisition of data on a module, power is supplied in a non-contact manner by magnetic field resonance to the sensor wafer 6 from the transfer arm G waiting in front of the module whose data is being acquired, so that the sensor wafer 6 can perform acquisition of data about the module and wireless communication of the data using the power. Therefore, it is unnecessary to provide, in the sensor wafer 6, a battery required for performing data acquisition. Accordingly, the bias of the weight and the balance of parts can be suppressed in the sensor wafer 6A, so that in detecting the coordinates of the rotation center of the spin chuck 22 in the solution treatment module, the acceleration to be detected can be made close to the acceleration in the actual treatment of the wafer W. Therefore, the coordinates can be detected with high accuracy. Since each wafer is automatically transferred by the transfer arm G, acquisition of data on the module can be efficiently performed.

The sensor wafer 6B is provided with no battery as has been described and therefore can perform measurement at a high temperature, for example, 250° C. to 450° C. Accordingly, as compared to the case of using the sensor wafer configured such that the battery is connected to the wafer via the cable as has been previously described in the item of the Description of the Related Art, the burden on the user is reduced and the measurement efficiency can be improved. Further, there is little projections and depressions on the wafer surface of the sensor wafer 6C, thus making it possible to make the direction and the air speed of airflow in the module closer to those at the time of transferring the wafer W thereinto and measure the direction and the air speed of the airflow with high accuracy.

The above-described configuration that each sensor wafer 6 is provided with no battery does not require changing the battery every time the battery life ends and thereby provides an advantage of being able to save the effort of maintenance. Further, there is no need to discard the dead battery, thus reducing the impact on the environment. Furthermore, since the time required to charge the battery is not necessary, the time required for the measurement can be reduced to improve the throughput.

Each of the modules provided in the coating and developing apparatus 1 has the air atmosphere therein, but the sensor wafer 6 can be used also in a vacuum atmosphere. In the vacuum atmosphere, a sensor wafer on which a lithium ion battery is mounted as the battery is susceptible to solution leakage of the treatment solution constituting the battery, whereas the above-described sensor wafer 6 is not susceptible to such solution leakage and is therefore effectively used.

Since the power receiving coil 63 is provided in a spiral form at the peripheral portion of the sensor wafer 6, the number of windings of the power receiving coil 63 can be increased and various circuits can be formed inside the power receiving coil 63 in the sensor wafer 6, thus providing an advantage that the degree of freedom of design is high.

Though the example in which the sensor wafers 6 are stored in the waiting module 4 has been described, the sensor wafers 6 can be housed in a dedicated carrier C, instead of providing such a waiting module 4, the carrier C is transferred to the mounting table 11 in the carrier block C1 at the time of inspection, and the sensor wafer 6 is taken out into the coating and developing apparatus 1 at the time of use in the first embodiment and later-described embodiments. Further, the waiting module 4 may be provided at any location as long as the sensor wafers 6 can be delivered to the transfer arms G, and may be provided, for example, in the shelf unit U5. Furthermore, a later-described power transmitting wafer 7 may be transferred to the carrier block C1 while being housed in the carrier C or kept waiting in each module from which the power transmitting wafer 7 can be delivered to the transfer arm G.

The kinds of the sensor mounted on the sensor wafer 6 and the module data to be acquired are not limited to those of this example, and the sensor wafer 6 may include, for example, an inclination sensor. The sensor wafer 6 in this case is transferred to each module and used for acquiring the inclination data about the module, and the installation state of the module can be verified based on the acquired data.

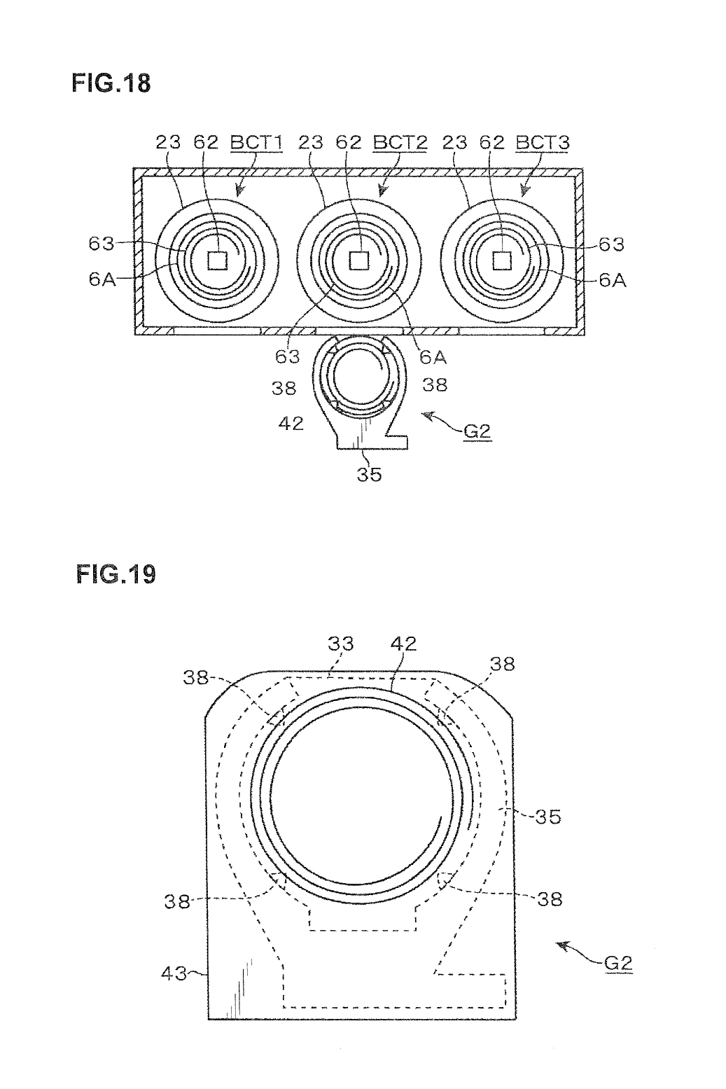

Though one sensor wafer 6 is delivered to each module to sequentially measure data about each module in the above embodiment, a plurality of pieces of inspection data may be acquired at the same time in the modules at the same floor. For example, the sensor wafers 6A are transferred into the anti-reflection film forming modules BCT1, BCT2, BCT3 respectively, and power is then supplied from the transfer arm G2 to the sensor wafers 6A to acquire data. Alternatively, the sensor wafers 6A are transferred into the anti-reflection film forming modules BCT1, BCT2, BCT3 respectively as illustrated in FIG. 18, and power is then supplied from the transfer arm G2 to all of the sensor wafers 6A to acquire data.

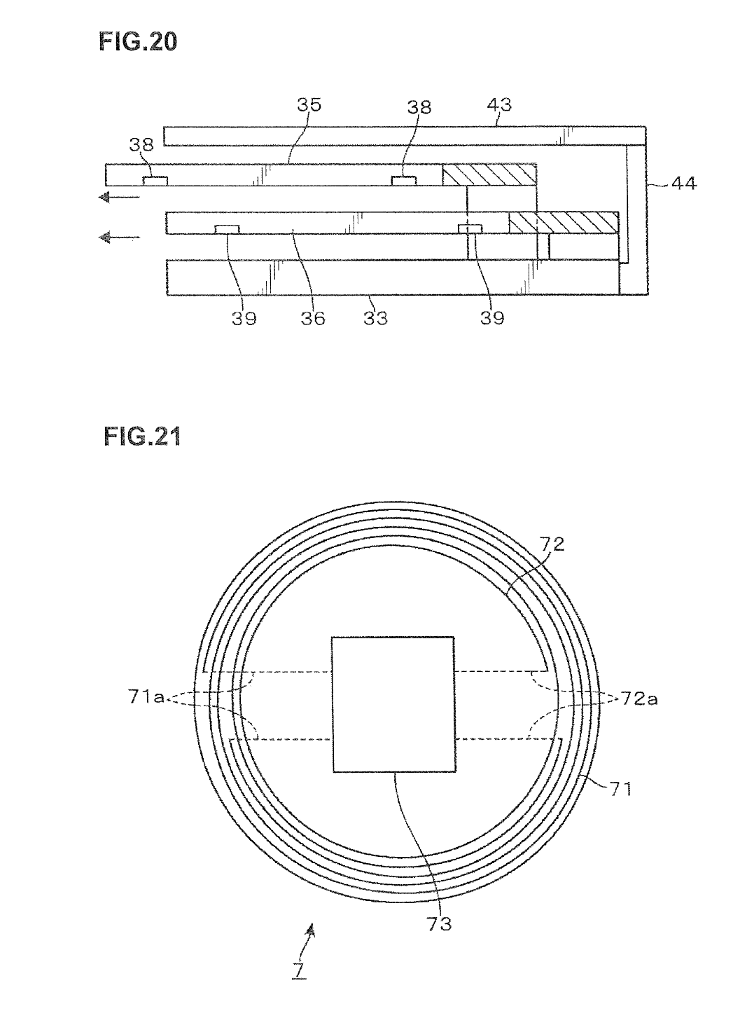

Incidentally, regarding the positional relation between the sensor wafer 6 and the transfer arm G, it is only necessary that the power receiving coil 63 of the sensor wafer 6 exists in the magnetic field formed by the power transmitting coil 42 at the time of the above-described wireless power supply, and therefore the position at which the power transmitting coil 42 in the transfer arm G is not limited to that in the above-described example. FIG. 19, FIG. 20 illustrate a plan view and a side view respectively of the transfer arm G2 whose power transmitting coil 42 is provided at the position different from that of the already-described example. In this example, a cover 43 covering the forks 35, 36 is provided above the forks 35, 36. On the surface of the cover 43, the power transmitting coil 42 is provided. Note that numeral 44 in FIG. 20 is a support portion supporting the cover on the base 34.

### Modification of the First Embodiment

The advantage when no battery is mounted on the sensor wafer 6 has been described, and the case that a battery is mounted on the sensor wafer 6 also falls within the scope of the right of the present invention. For example, a battery composed of an electric double layer capacitor is mounted, and this battery is used as the power supply for the wireless communication by the antenna 68. Further, the circuits of the sensor wafer 6 are configured such that power is supplied to the circuits of the sensor wafer 6 and charged into the battery at the above-described Steps S3 to S7. Furthermore, the apparatus controller 54 is set such that the power supply to the power transmitting coil 42 is automatically stopped after a lapse of a predetermined time from the delivery of the sensor wafer 6 to the module. In addition, the communication circuit 67 of the sensor wafer 6 is configured such that after the stop of the power supply, the communication circuit 67 wirelessly transmits the acquired data about the module to the coating and developing apparatus 1 using the power of the battery. By the communication in such a state that the magnetic field is not formed, the transmission of data can be more surely performed. In the later-described embodiments, the battery for communication may be provided on the sensor wafer 6 as described above to perform data communication.

### Second Embodiment

Next, a second embodiment will be described. In this second embodiment, power is supplied from the transfer arm G to the sensor wafer 6 via the power transmitting wafer 7. The power supply between the transfer arm G and the power transmitting wafer 7 and between the power transmitting wafer 7 and the sensor wafer 6 is performed by the wireless power supply using a magnetic field resonance system as in the first embodiment. FIG. 21 is a plan view of the power transmitting wafer 7. At the peripheral portion of the power transmitting wafer 7, a power receiving coil 71 and a power transmitting coil 72 are provided. The power receiving coil 71 and the power transmitting coil 72 are planar coils, and conductive wires of the coils are provided in a spiral form at the peripheral portion of the power transmitting wafer 7.

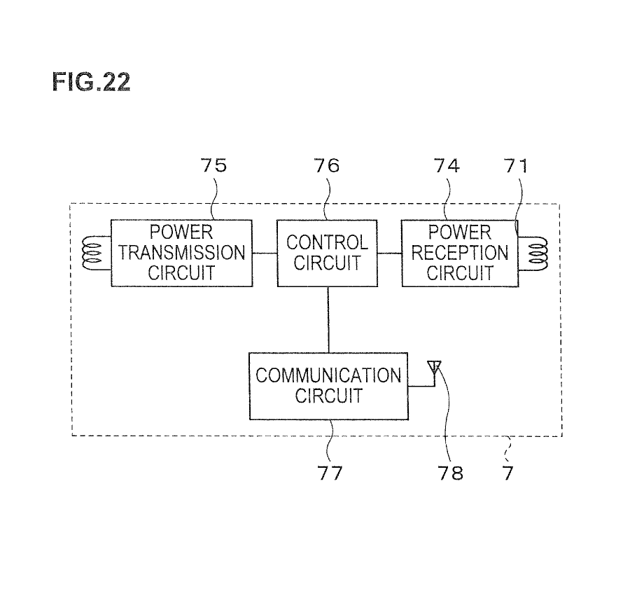

At a central portion of the power transmitting wafer 7, a circuit part 73 connected to the power receiving coil 71 and the power transmitting coil 72 is provided. In FIG. 21, numerals 71a, 72a denote wires connecting the power receiving coil 71 and the power transmitting coil 72 to the circuit part 73 respectively. FIG. 22 is a schematic circuit diagram of the power transmitting wafer 7, and the circuit part 73 includes a power reception circuit 74, a power transmission circuit 75, a control circuit 76, a communication circuit 77, and an antenna 78 illustrated in FIG. 22. The power reception circuit 74 is connected to the power receiving coil 71, and the power transmission circuit 75 is connected to the power transmitting coil 72. The control circuit 76 is connected to the power reception circuit 74 and the power transmission circuit 75. Further, the control circuit 76 is connected to the communication circuit 77, and the antenna 78 is connected to the communication circuit 77.

The power supplied to the power receiving coil 71 is supplied to the power reception circuit 74, the control circuit 76, the power transmission circuit 75 and the power transmitting coil 72. The power reception circuit 74 is a circuit for supplying the power supplied thereto from the power receiving coil 71 to the circuits at the subsequent stage. The power transmission circuit 75 is a circuit for outputting the power supplied thereto from the previous stage side to the power transmitting coil 72. The control circuit 76 controls the power to be supplied to the power transmission circuit 75 and the operation of the communication circuit 77. The communication circuit 77 controls the output of a signal transmitted from the antenna 78 to the sensor wafer 6 and the coating and developing apparatus 1.

The power transmitting wafer 7 is housed in the waiting module 4, for example, together with the sensor wafers 6, and is delivered from the waiting module 4 to the transfer arm G1 to G3 when it is collects data about the module. The transfer arm G1 to G3 receives the power transmitting wafer 7 and the sensor wafer 6 by the upper fork 35 and the lower fork 36 respectively and transfers the wafers among the modules.

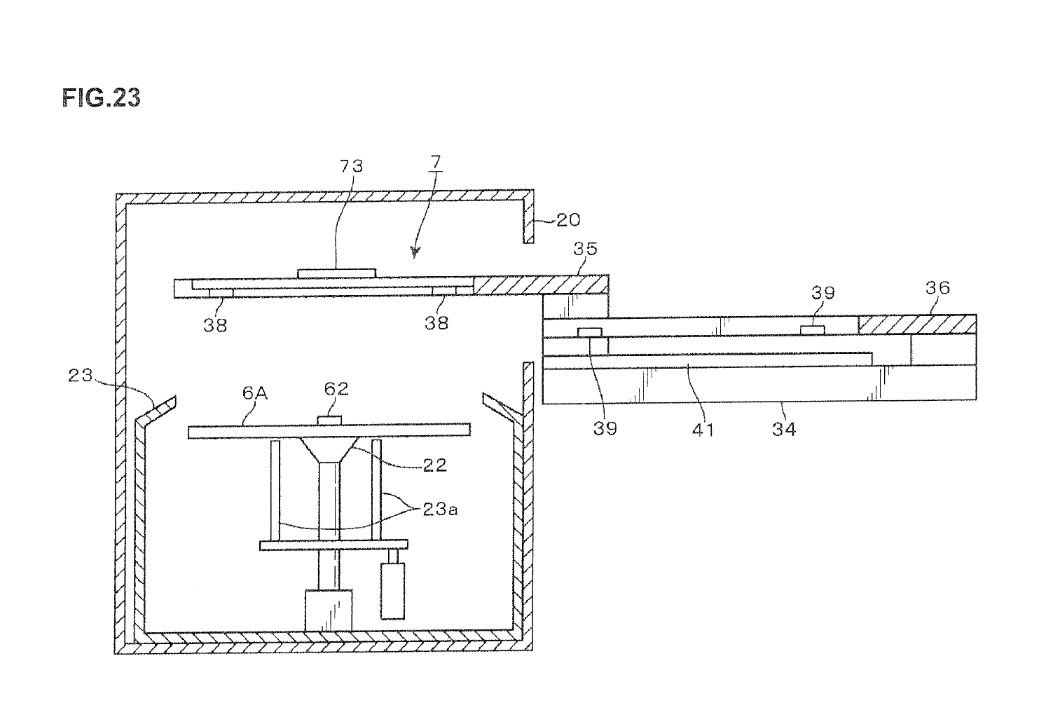

The method of acquiring data about the anti-reflection film forming module BCT in the second embodiment will be described mainly for the different points from the first embodiment. When the sensor wafer 6A and the power transmitting wafer 7 are delivered to the transfer arm G2 and the base 34 of the transfer arm G2 is located in front of the anti-reflection film forming module BCT1 as with Steps S1, S2 in the first embodiment and the sensor wafer 6 is delivered from the lower fork 36 to the anti-reflection film forming module BCT1, the upper fork 35 moves forward to the anti-reflection film forming module BCT1 so that the power transmitting wafer 7 is located above the sensor wafer 6A as illustrated in FIG. 23.

Subsequently, electric current is supplied to the power transmitting coil 42 of the transfer arm G, the power transmitting coil 42 and the power receiving coil 71 of the power transmitting wafer 7 resonate so that power is wirelessly supplied to the power receiving coil 71 and the power reception confirmation signal is wirelessly transmitted from the antenna 78 of the power transmitting wafer 7 to the antenna 55 of the coating and developing apparatus 1. Then, power is supplied to the power transmitting coil 72 of the power transmitting wafer 7, the power transmitting coil 72 and the power receiving coil 63 of the sensor wafer 6A resonate so that power is wirelessly supplied to the power receiving coil 63. Then, as in the first embodiment, the power reception confirmation signal and the measurement data are wirelessly transmitted from the sensor wafer 6A to the antenna 55, and the coordinates of the rotation center of the spin chuck 22 in the anti-reflection film forming module BCT1 are specified.

When the coordinates of the rotation center are specified, the upper fork 35 moves backward from the anti-reflection film forming module BCT1 while holding the power transmitting wafer 7. Subsequently, the sensor wafer 6A is delivered to the lower fork 36, and the lower fork 36 then moves backward. Thereafter, the base 34 of the transfer arm G2 moves to the front of the anti-reflection film forming module BCT2 as in the first embodiment, and the coordinates of the rotation center of the spin chuck 22 in the anti-reflection film forming module BCT2 are specified as in the anti-reflection film forming module BCT1. Thereafter, the coordinates are specified also in the other solution treatment modules in sequence. Note that if the reception confirmation signal is not transmitted from both or one of the power transmitting wafer 7 and the sensor wafer 6A when power has been supplied to the power transmitting coil 42 of the transfer arm G, the apparatus controller 54 stops the power supply and displays an alarm.

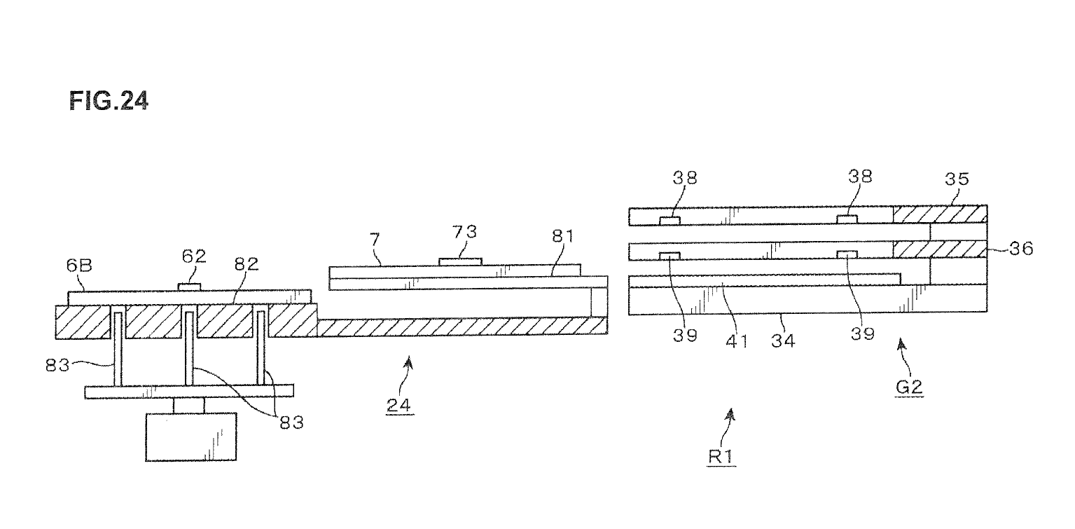

Next, the configuration of the heating module 24 will be described in detail referring to FIG. 1 and FIG. 24 in order to describe the method of acquiring the data about the heating module 24 using the power transmitting wafer 7 and the sensor wafer 6B. FIG. 24 is a longitudinal section side view of the heating module 24. The heating module 24 includes a cooling plate 81 provided on the front side as seen from the transfer region R1 and a hot plate 82 provided on the back side. The cooling plate 81 transfers the wafer W mounted thereon from the front side onto the hot plate 82 on the back side and cools the wafer W. Each wafer is delivered between the cooling plate 81 and the transfer arm G by the rising and lowering operation of the transfer arm G.

The hot plate 82 heats the wafer W mounted thereon as already described. Further, the hot plate 82 includes raising and lowering pins 83 projecting to above the hot plate 82 so that the wafer W is delivered between the cooling plate 81 and the hot plate 82 via the raising and lowering pins 83. Note that numeral 84 in FIG. 1 denotes slits provided in the cooling plate 81 which are configured such that the raising and lowering pins 83 pass therethrough to project to above the cooling plate 81.

Hereinafter, the method of acquiring the data on the heating temperature of the hot plate 82 in the heating module 24 will be described. As illustrated in FIG. 24, the sensor wafer 6B is delivered from the transfer arm G2 located in front of the heating module 24 to the hot plate 82, and the power transmitting wafer 7 is delivered to the cooling plate 81. As with the time when acquiring the data about the solution treatment module, power is supplied in a non-contact manner from the base 34 of the transfer arm G2 to the sensor wafer 6B via the power transmitting wafer 7 so that the sensor wafer 6B is heated, and the data on the temperature is transmitted to the coating and developing apparatus 1. After the data acquisition, the sensor wafer 6B and the power transmitting wafer 7 are delivered again to the transfer arm G2, transferred to another heating module 24 in which acquisition of data about the heating module 24 is successively performed. Also in the heating modules 24 in the COT floor B3 and the DEV floor B1, data on the heating temperature is acquired.

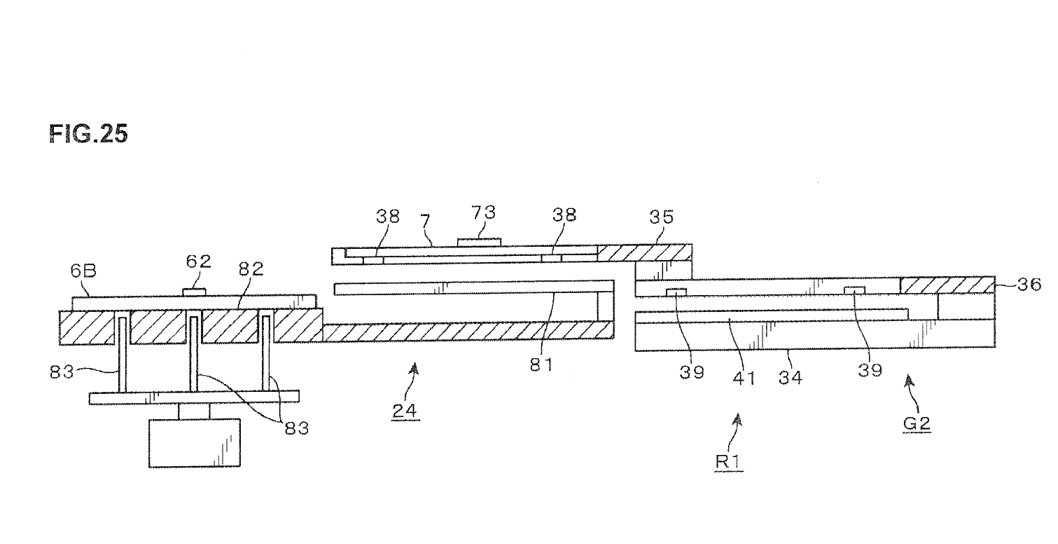

The second embodiment has the same effects as those of the first embodiment. Further, by locating the power transmitting wafer 7 close to the sensor wafer 6B as described above, power can be supplied more surely to the sensor wafer 6B. Furthermore, for acquiring the data about the heating module 24, the upper fork 35 holding the power transmitting wafer 7 thereon may be moved forward to the heating module 24 as illustrated in FIG. 25 instead of mounting the power transmitting wafer 7 on the cooling plate 81. This movement locates the power transmitting wafer 7 also close to the sensor wafer 6B, thus ensuring that power is more surely supplied to the sensor wafer 6B.

### Modification of Second Embodiment

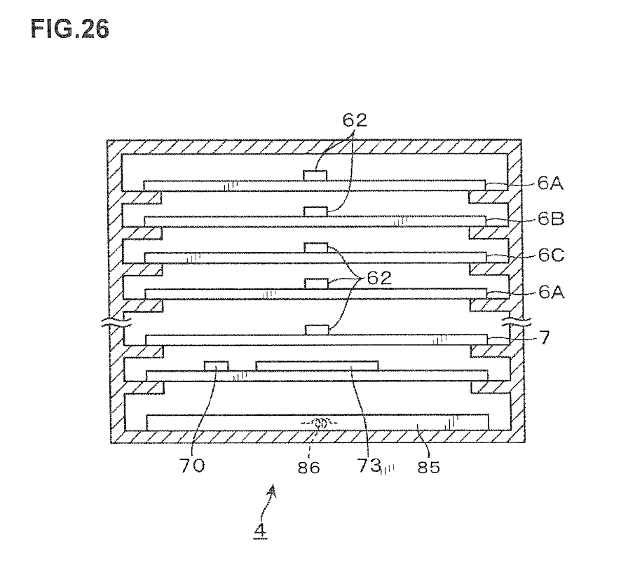

For example, a battery 70 composed of an electric double layer capacitor may be provided on the power transmitting wafer 7 to supply the power stored in the battery 70 to the sensor wafer 6. For example, during the time when the power transmitting wafer 7 is waiting in the waiting module 4, the battery 70 is charged. FIG. 26 is a longitudinal section side view of the waiting module 4 having such a charging function. In the drawing, 85 denotes a power transmission part, and this power transmission part 85 includes a power transmitting coil 86 to supply power in a non-contact manner from the power transmitting coil 86 to the power receiving coil 71 of the power transmitting wafer 7 by a magnetic field resonance system, and the transmitted power is stored in the battery 70.

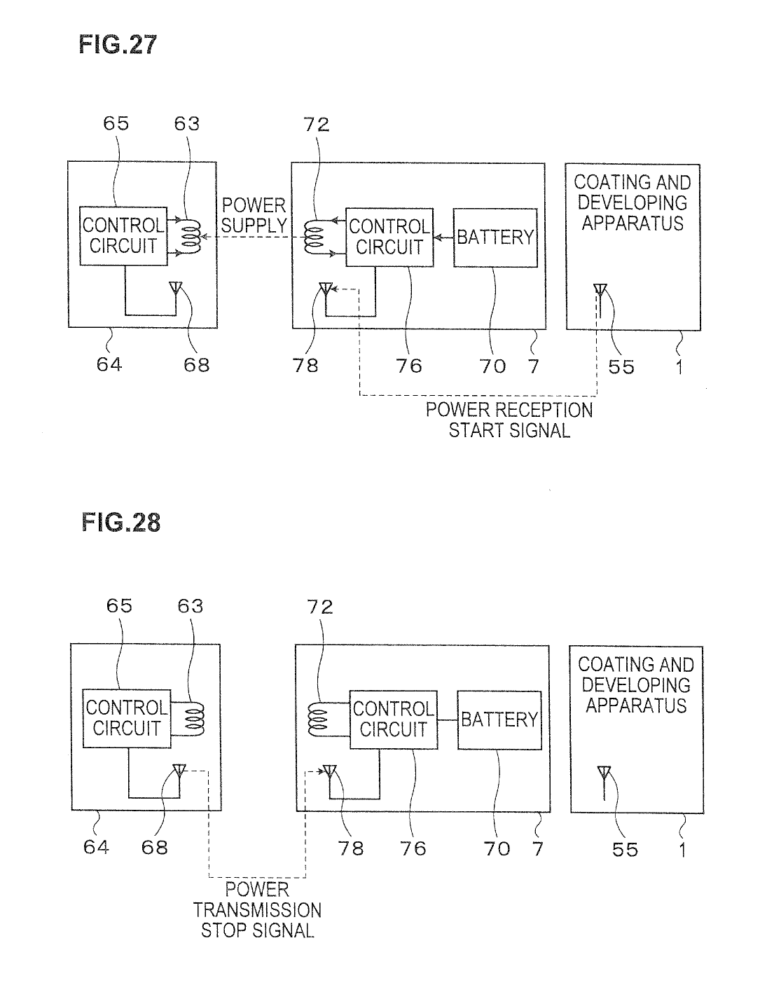

The control circuit 76 of the power transmitting wafer 7 is connected to the battery 70 to control the supply and stop of the power from the battery 70 to the power transmitting coil 72. In the case of acquiring the data about each solution treatment module, when the upper fork 35 of the transfer arm G holding the power transmitting wafer 7 thereon moves forward to the solution treatment module as illustrated, for example, in already-described FIG. 23, the positional signal of the upper fork 35 triggers transmission of a power reception start signal from the antenna 55 of the coating and developing apparatus 1 to the antenna 78 of the power transmitting wafer 7 as illustrated in FIG. 27. In the power transmitting wafer 7 received the power reception start signal, power is supplied by the control circuit 76 from the battery 70 to the power transmitting coil 72, whereby wireless power supply to the sensor wafer 6A is performed. Note that FIG. 27 and FIG. 28 subsequent thereto are schematic views illustrated for simplifying the explanation of the transmission and reception of signals and the power supply from the battery 70, in which wafers and circuits such as the power reception circuit, power transmission circuit, communication circuit and so on which have been already described in the apparatus are omitted, those circuits are provided as in each of the above-described embodiments.

Upon completion of the data acquisition by the sensor wafer 6A, the power transmission stop signal is transmitted from the sensor wafer 6A to the power transmitting wafer 7 as illustrated in FIG. 28. This signal triggers the control circuit 76 to stop the power supply from the battery 70 to the power transmitting coil 72. Also in the case of acquiring the data about the heating module 24, the transmission and reception of signals is similarly performed.

Since the power transmitting wafer 7 is not used directly for measurement of the module, the impact on the accuracy of measurement of the module is reduced even if the battery 70 is provided on the power transmitting wafer 7. Accordingly, the same effects as those of the first and second embodiments can be achieved also in the modification of the second embodiment. Note that the place where the charge of the power transmitting wafer 7 is not limited to the waiting module 4 but, for example, a dedicated module for charging may be provided in the shelf unit U5 or the charged power transmitting wafer 7 may be transferred using the carrier C from the outside of the coating and developing apparatus 1 into the treatment block C2.

### Third Embodiment

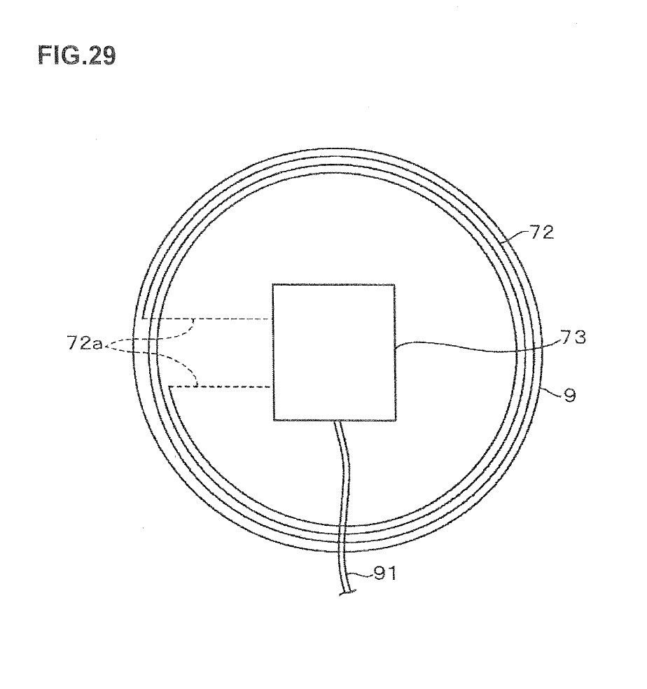

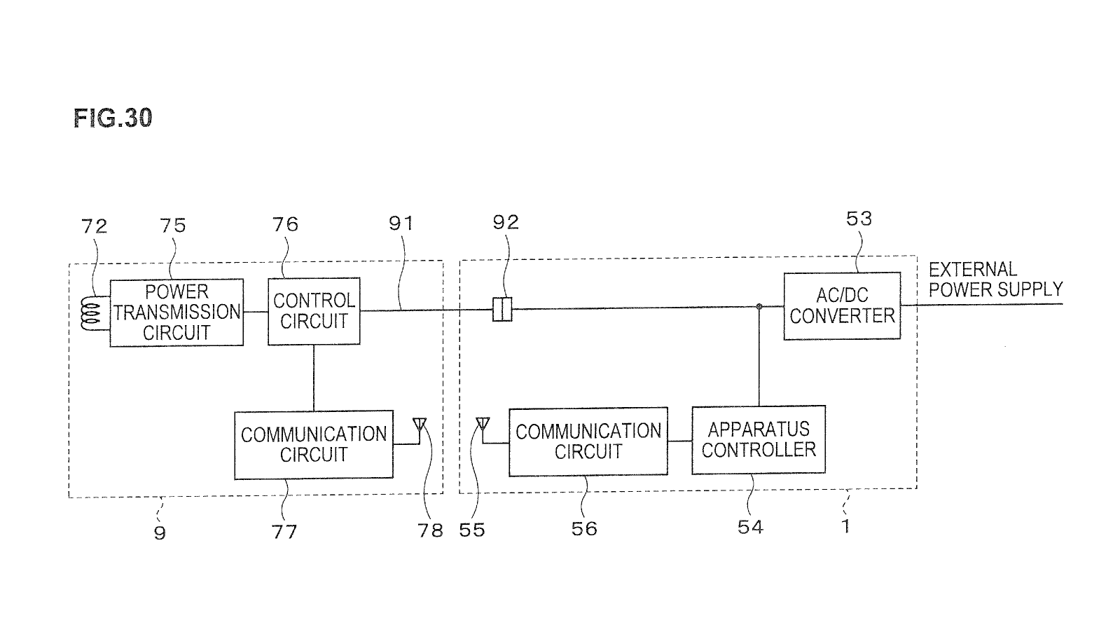

In place of the wireless power supply between the power transmitting wafer and the coating and developing apparatus 1 in the second embodiment, the power transmitting wafer may be connected to the coating and developing apparatus 1 by wire so that power is supplied from the coating and developing apparatus 1 to the power transmitting wafer. FIG. 29 is a plan view of a power transmitting wafer 9 including a cable 91 for the wire connection as described above. FIG. 30 is a schematic circuit diagram of the power transmitting wafer 9 and the coating and developing apparatus 1 connected to the power transmitting wafer 9. The different points of the power transmitting wafer 9 from the power transmitting wafer 7 include the point that the power receiving coil 71 and the power reception circuit 74 are not provided. Further, the cable 91 is connected to the control circuit 76 of the power transmitting wafer 9, in place of the power reception circuit 74. The power transmitting wafer 9 is connected to the AC/DC converter 53 of the coating and developing apparatus 1 via the cable 91. In FIG. 30, numeral 92 is a connection part between the cable 91 and the coating and developing apparatus 1. In the third embodiment using the power transmitting wafer 9, the measurement is performed as in the second embodiment except that the user mounts the power transmitting wafer 9 on the transfer arm G at the time of measurement.

Preferred embodiments of the present invention have been described above with reference to the accompanying drawings, but the present invention is not limited to the embodiments. It should be understood that various changes and modifications are readily apparent to those skilled in the art within the scope of the spirit as set forth in claims, and those should also be covered by the technical scope of the present invention.

What is claimed is:

1. A method of acquiring data of a substrate treatment apparatus comprising a substrate transfer mechanism including a base and a holding member provided on the base to be movable forward and backward, for transferring a substrate between a plurality of modules, said method comprising the steps of:
holding a sensor substrate on the holding member, the sensor substrate comprising a sensor part for collecting information about the module and a power receiving coil for supplying power to the sensor part;
then moving the holding member forward to deliver the sensor substrate to the module;
supplying power to a power transmitting coil moving together with the base to form a magnetic field, and causing the power transmitting coil and the power receiving coil to resonate in the magnetic field to supply power from the power transmitting coil to the power receiving coil; and
acquiring data about the module by the sensor part.

2. The data acquisition method of a substrate treatment apparatus as set forth in claim 1,
wherein the sensor substrate comprises a wireless communication part supplied with power from the power receiving coil, and
wherein said method further comprises the step of transmitting the data about the module from the wireless communication part to a reception part of the substrate treatment apparatus.

3. The data acquisition method of a substrate treatment apparatus as set forth in claim 2, further comprising the step of:
when power has been supplied to the power receiving coil, transmitting a confirmation signal indicating that power has been supplied, from the wireless communication part to the reception part.

4. A method of acquiring data of a substrate treatment apparatus comprising a substrate transfer mechanism including a base and a holding member provided on the base to be movable forward and backward, for transferring a substrate between a plurality of modules, said method comprising the steps of:
holding a sensor substrate on the holding member, the sensor substrate comprising a sensor part for collecting information about the module and a first power receiving coil for supplying power to the sensor part;
then moving the holding member forward to deliver the sensor substrate to the module;
holding a power transmitting substrate comprising a first power transmitting coil, on the holding member;
supplying power to the first power transmitting coil to form a magnetic field, and causing the first power transmitting coil and the first power receiving coil to resonate in the magnetic field to supply power from the first power transmitting coil to the first power receiving coil; and
acquiring data about the module by the sensor part.

5. The data acquisition method of a substrate treatment apparatus as set forth in claim 4,
wherein the sensor substrate comprises a first wireless communication part supplied with power from the first power receiving coil, and
wherein said method further comprises the step of transmitting the data about the module from the first wireless communication part to a reception part of the substrate treatment apparatus.

6. The data acquisition method of a substrate treatment apparatus as set forth in claim 5, further comprising the step of:
when power has been transmitted to the first power receiving coil, transmitting a confirmation signal indicating that power has been supplied, from the first wireless communication part to the reception part.

7. The data acquisition method of a substrate treatment apparatus as set forth in claim 4,
wherein the power transmitting substrate comprises a second power receiving coil for supplying power to the first power transmitting coil, and
wherein said method further comprises the step of supplying power to a second power transmitting coil moving together with the base to form a magnetic field, and causing the second power transmitting coil and the second power receiving coil to resonate in the magnetic field to supply power from the second power transmitting coil to the second power receiving coil in a non-contact manner.

8. The data acquisition method of a substrate treatment apparatus as set forth in claim 7,
wherein the power transmitting substrate comprises a second wireless communication part supplied with power from the second power receiving coil, and
wherein said method further comprises the step of, when power has been supplied to the second power receiving coil, transmitting a confirmation signal indicating that power has been supplied, from the second wireless communication part to a reception part provided in the substrate treatment apparatus.

9. The data acquisition method of a substrate treatment apparatus as set forth in claim 4,
wherein the power transmitting substrate comprises a battery for supplying power to the first power transmitting coil.

10. A sensor substrate configured to be transferable by a substrate transfer device to a module into which a substrate being a treatment object is transferred, said sensor substrate comprising:
a sensor part for collecting various kinds of data information supplied for process treatment in the module;
a transmission part wirelessly transmitting the data information collected by said sensor part; and
a power receiving coil connected to said sensor part and transmission part, for receiving power transmitted by a resonance effect from an outside and supplying the power to said sensor part and transmission part.

11. The sensor substrate as set forth in claim 10,
wherein said power receiving coil is provided in a spiral form along an outer shape of said sensor substrate at a peripheral portion of said sensor substrate.
